(19) United States
(12) Patent Application Publication
(10) Pub. No.: US 2009/0268036 A1
(43) Pub. Date: Oct. 29, 2009

(54) METHOD AND SYSTEM FOR TESTING GRADATION LEVELS

(75) Inventor: MENG-CHIEH CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/334,528

(22) Filed: Dec. 15, 2008

(30) Foreign Application Priority Data
Apr. 28, 2008 (CN) 200810301337.0

(51) Int. Cl. H04N 17/02

(52) U.S. Cl. 348/189; 348/E17.004

(57) ABSTRACT

A method and system for testing gradation levels of a display panel of an electronic device are provided. The method includes dividing a display area of the display panel into 2̂n blocks and assigning corresponding gradation values for each of the blocks, displaying the gradation levels of each of the blocks on the display panel, scanning each of the blocks and outputting the gradation values of each of the blocks, and determining a defectiveness of the display panel depending on the outputted gradation values and the assigned gradation values of each of the blocks.

### BACKGROUND

1. Field of the Invention

Embodiments of the present disclosure relate to gradation levels, and more particularly to a method and a system for testing gradation levels of a display on an electronic device.

2. Description of Related Art

In digital imaging, a pixel is the smallest piece of information in an image, and each pixel has three components such as red, green, and blue. The intensity of each pixel is variable, and different gradation levels indicate different intensities. The more gradation levels the image has, the more delicate the image is. For example, a 8-bit display panel is capable of displaying 256 gradation levels.

Generally, gradation tests have to be performed for the display panel because it is difficult to unify the intensity of the red, green, and blue components. The number of times the gradation tests have to be performed depends on the number of gradation levels the display panel has. For example, for the 8-bit display panel, the display panel has to be respectively set for 256 gradation levels for each test. Thus, the related gradation tests are deemed time consuming.

Accordingly, a method and a system for testing gradation levels of a display panel on an electronic device are called for in order to overcome the limitations described.

### BRIEF DESCRIPTION OF THE DRAWINGS

FIG. 1 is a block diagram of an embodiment of a system for testing gradation levels of a display panel;

FIG. 2 shows one example of a block of a 1-bit display panel;

FIG. 3 shows one example of blocks of a 4-bit display panel; and

FIG. 4 is a flowchart of an embodiment of a method for testing the gradation levels of a display panel.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

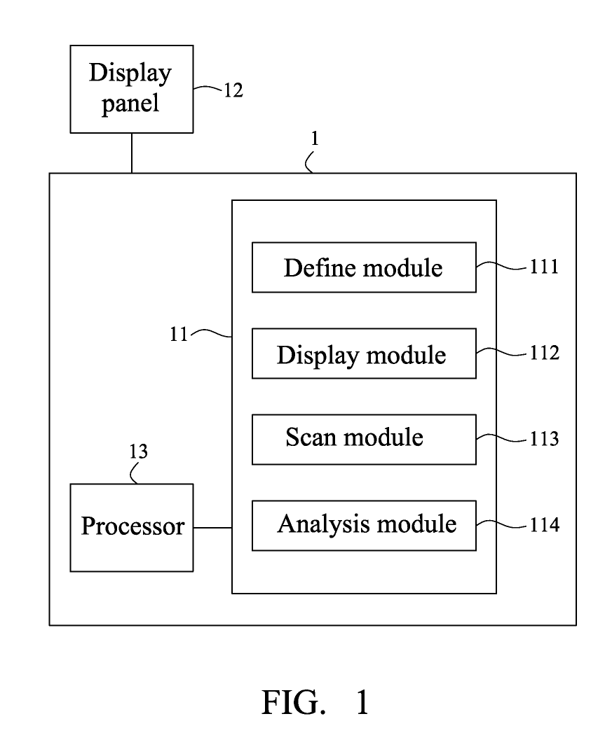

FIG. 1 is a block diagram of an embodiment of a system 11 for testing gradation levels of a display panel 12 (hereinafter “the system 11”). An electronic device 1 connected to the display panel 12, such as a desktop computer, includes the processor 13 and the system 11 for testing the gradation levels of the display panel 12. In other embodiments, the electronic device 1 may be, a notebook computer, a server, or other electronic device, without departing from the spirit of the disclosure.

In one embodiment, the system 11 includes a define module 111, a display module 112, a scan module 113, an analysis module 114, in addition to other hardware and software components of the electronic device 1.

The define module 111 is configured for dividing a display area of the display panel 12 into 2̂n blocks 20 wherein n is the number of bits per pixels of the display area, and for dividing each blocks 20 into a central area 20a and a peripheral area 20b. The define module 111 is also further configured for respectively assigning different gradation values to adjacent blocks 20, and assigning two adjacent gradation values, one gradation value to the central area 20a and one gradation value to the peripheral area 20b of the blocks 20.

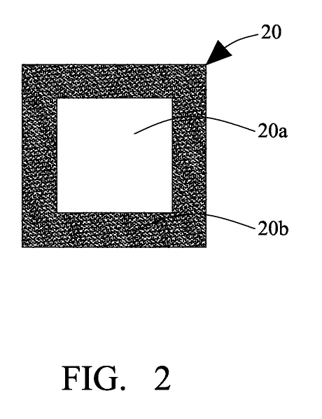

It is to be noted that a n-bit display panel 12 is capable of displaying 2̂n gradation levels. For example, a 1-bit display panel 12 is capable of displaying 2̂1 gradation levels, such as “white” with a gradation value equal to “0,” and “black” with the gradation value equal to “255.” As shown in FIG. 2, the block 20 is divided into the central area 20a and the peripheral area 20b. The gradation value of the central area 20a and the peripheral area 20b are respectively defined as “0” and “255.” The difference between the two gradation values equals to 255.

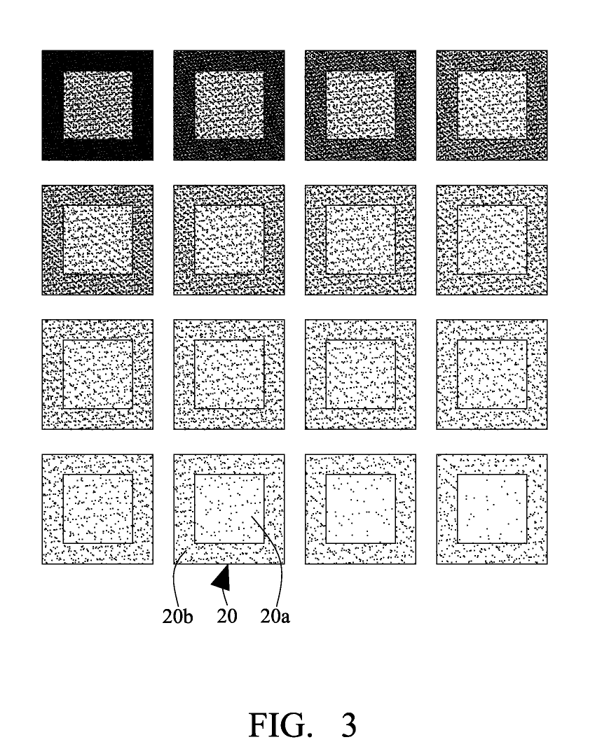

FIG. 3 shows one example of blocks 20 of a 4-bit display panel 12. In this example, the 4-bit display panel 12 is capable of displaying 2̂4 gradation levels, and the difference between the two gradation values equals to 16. Thus, the gradation values of the central area 20a and the peripheral area 20b of the 16 blocks are respectively as follows: (0, 16), (16, 32), (32, 48), (48, 64), (64, 80), (80, 96), (96, 112), (112, 128), (128, 144), (144, 160), (160, 176), (176, 192), (192, 208), (208, 224), (224, 240), and (240, 255).

The scan module 113 is configured for displaying the blocks 20, including the central area 20a and the peripheral area 20b, according to the assigned gradation values on the display panel 12. It is to be noted that as stated above, two adjacent gradation values are respectively assigned to the central area 20a and to the peripheral area 20b of the blocks 20. Thus, the defectiveness of the display panel 12 may be easily detected by a user by determining whether the central area 20a and the peripheral area 20b display substantially the same gradation levels.

The analysis module 114 is configured for scanning all of the blocks 20 so as to obtain the gradation values of the blocks 20. The analysis module 114 is further configured for calculating a gamma coefficient according to the outputted gradation values from the scan module 113 and the assigned gradation values of the blocks 20. Therefore, the analysis module 114 determines the defectiveness by comparing the calculated gamma coefficient with a standard gamma coefficient of the display panel 12. If the calculated gamma coefficient does not match with the standard gamma coefficient, then the display panel is determined to be defective. It may be understood that there may an allowable defective error of the display panel 12. The allowable defective error, in one embodiment, may be based on a percentage difference of the calculated gamma coefficient and the standard gamma coefficient.

In one exemplary embodiment, an equation for calculating the gamma coefficient is as follows, wherein the outputted gradation values from the scan module 113 is referred to as “OutputtedValue” and the assigned gradation value of the blocks 20 is referred to as “AssignedValue.”

$$OutputtedValue = 255 {x [ \frac{AssignedValue}{255} ]}^{gamma}$$

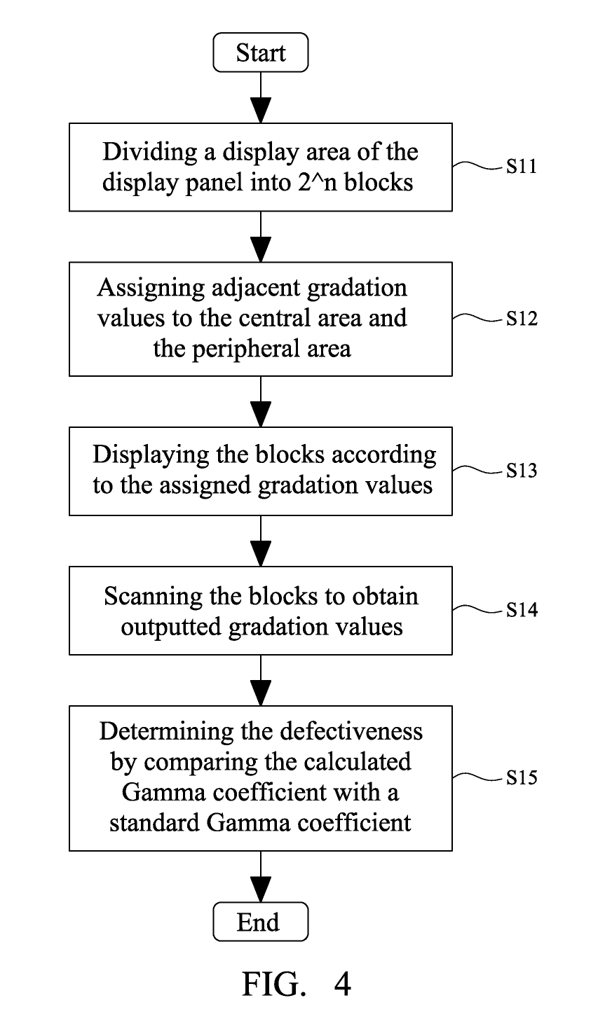

FIG. 4 is a flowchart of an embodiment of a method for testing gradation levels of the display panel 12. The method of FIG. 4 may used for determining a defectiveness of the display panel 12 by scanning the blocks 20 of the display panel 12 and calculating a gamma coefficient accordingly. Depending on the embodiment, additional blocks may be added or deleted and the blocks may be executed in order other than that described.

In block S11, the define module 111 divides a display area of the display panel 12 into 2̂n blocks 20. Each of the blocks 20 includes the central area 20a and the peripheral area 20b. In block S12, the define module 111 assigns different gradation values to adjacent blocks 20, and assigns adjacent gradation value to the central area 20a and the peripheral area 20b.

In block S13, the display module 112 displays gradation levels of each of the blocks 20 on the display panel 12 according to the assigned gradation values.

In block S14, the analysis module 114 scans all of the blocks 20 to obtain the gradation value of the blocks 20 shown on the display panel 12. In block S15, the analysis module 114 determines the defectiveness of the display panel 12 by comparing the calculated gamma coefficient with a standard gamma coefficient of the display panel 12. The gamma coefficient is calculated according to the outputted gradation value from the scan module 113 and the assigned gradation value of the blocks 20. In the embodiment, the analysis module 114 is configured for popping up a window indicating that the display panel 12 is defective upon determining the defectiveness.

It is important to note that while the disclosure has been described in the context of a fully functioning data processing system, those of ordinary skill in the art will appreciate that the processes of the disclosure are capable of being distributed in the form of a computer readable medium of instructions and a variety of forms and that the disclosure applies equally regardless of the particular type of signal bearing media actually used to carry out the distribution. Examples of computer readable media include recordable-type media such as floppy disc, a hard disk drive, random access memory (RAM), and compact disc-read only memory (CD-ROM), as well as transmission-type media, such as digital and analog communications links.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for testing gradation levels of a display panel of an electronic device, the system comprising:
a define module configured for dividing a display area of the display panel into 2̂n blocks wherein n is the number of bits per pixels of the display panel, and for assigning corresponding gradation values for each of the blocks;
a display module configured for displaying gradation levels of each of the blocks on the display panel;
a scan module configured for scanning the blocks and for outputting the gradation values of each of the blocks; and
an analysis module configured for determining a defectiveness of the display panel according to the outputted gradation values from the scan module and the assigned gradation values of each of the blocks.

2. The system as claimed in claim 1, wherein the analysis module calculates a gamma coefficient according to the assigned gradation level and the outputted gradation values from the scan module, and compares the calculated gamma coefficient with a standard gamma coefficient of the display panel so as to determine the defectiveness of the display panel.

3. The system as claimed in claim 2, wherein the define module is configured for dividing each of the blocks into a central area and a peripheral area.

4. The system as claimed in claim 3, wherein the define module is further configured for respectively assigning two adjacent gradation values to the central area and to the peripheral area of each of the blocks.

5. The system as claimed in claim 4, wherein different gradation values are assigned to adjacent blocks on the display area.

6. The system as claimed in claim 5, wherein the analysis module is further configured for determining the defectiveness of each of the blocks if the outputted gradation values of the central area and the peripheral area of each of the blocks are substantially the same.

7. A computer-implemented method for testing gradation levels of a display panel of an electronic device, the method comprising:
dividing a display area of the display panel into 2̂n blocks wherein n is the number of bits per pixels of the display panel;
assigning corresponding gradation values for each of the blocks;
displaying gradation levels of each of the blocks on the display panel;
scanning each of the blocks and outputting the gradation values of each of the blocks; and
determining a defectiveness of the display panel depending on the outputted gradation values and the assigned gradation values of each of the blocks.

8. The method as claimed in claim 7, wherein the determining step further comprises:
calculating a gamma coefficient according to the assigned gradation levels and the outputted gradation values; and
comparing the calculated gamma coefficient with a standard gamma coefficient of the display panel so as to determine the defectiveness.

9. The method as claimed in claim 8, wherein the dividing step further comprises:
dividing each of the blocks into a central area and a peripheral area.

10. The method as claimed in claim 9, wherein the assigning step further comprises:
respectively assigning two adjacent gradation values to the central area and to the peripheral area of each of the blocks.

11. The method as claimed in claim 10, wherein the gradation values of each adjacent block are different.

12. The method as claimed in claim 11, wherein the determining step further comprises:
determining the defectiveness of each of the blocks if the outputted gradation values of the central area and the peripheral area of each of the blocks are substantially the same.

13. A computer-readable medium for testing gradation levels of a display panel of an electronic device, the computer-readable medium having stored thereon instructions that, when executed by the electronic device, cause the electronic device to:
divide a display area of the display panel into 2̂n blocks wherein n is the number of bits per pixels of the display panel;
assign corresponding gradation values for each of the blocks;
display gradation levels of each of the blocks on the display panel;
scan each of the blocks and outputting the gradation values of each of the blocks; and
determine a defectiveness of the display panel depending on the outputted gradation values and the assigned gradation values of each of the blocks.

14. The computer-readable medium as claimed in claim 13, wherein the determining step further comprises:
calculating a gamma coefficient according to the assigned gradation levels and the outputted gradation values; and
comparing the calculated gamma coefficient with a standard gamma coefficient of the display panel so as to determine the defectiveness.

15. The computer-readable medium as claimed in claim 14, wherein the dividing step further comprises:
dividing each of the blocks into a central area and a peripheral area.

16. The computer-readable medium as claimed in claim 15, wherein the assigning step further comprises:
respectively assigning two adjacent gradation values to the central area and to the peripheral area of each of the blocks.

17. The computer-readable medium as claimed in claim 16, wherein the gradation values of each adjacent block are different.

18. The computer-readable medium as claimed in claim 17, wherein the determining step further comprises:
determining the defectiveness of each of the blocks if the outputted gradation values of the central area and the peripheral area of each of the blocks are substantially the same.
